(19) United States
(12) Patent Application Publication
(10) Pub. No.: US 2024/0154171 A1
(43) Pub. Date: May 9, 2024

(54) ELECTROLYTIC SOLUTION AND LITHIUM METAL SECONDARY BATTERY

(71) Applicant: HONDA MOTOR CO., LTD., Tokyo (JP)

(72) Inventors: Ken BABA, Saitama (JP); Takeshi FUJINO, Saitama (JP); Tomohiro KINOSHITA, Saitama (JP); Wataru HOSHIKAWA, Saitama (JP)

(21) Appl. No.: 18/495,767

(22) Filed: Oct. 27, 2023

(30) Foreign Application Priority Data
Nov. 4, 2022 (JP) 2022-177364

(51) Int. Cl. H01M 10/0568; H01M 10/052; H01M 10/0569

(52) U.S. Cl. CPC H01M 10/0568; H01M 10/052; H01M 10/0569; H01M 2300/0037

(57) ABSTRACT

The present invention provides an electrolytic solution comprising a lithium salt and an organic solvent, wherein the lithium salt has a concentration of 2.0 mol/L or more and 3.0 mol/L or less, the lithium salt comprises a first lithium salt and a second lithium salt, the first lithium salt is lithium bis(fluorosulfonyl)imide, and the second lithium salt is one or more selected from the group consisting of lithium hexafluorophosphate, lithium difluoro(oxalato)borate and lithium difluorophosphate.

This application is based on and claims the benefit of priority from Japanese Patent Application No. 2022-177364, filed on 4 Nov. 2022, the content of which is incorporated herein by reference.

### BACKGROUND OF THE INVENTION

### Field of the Invention

The present invention relates to an electrolytic solution and a lithium metal secondary battery.

### Related Art

In recent years, secondary batteries that contribute to energy efficiency have been researched and developed to ensure that more people have access to affordable, reliable, sustainable, and advanced energy.

As a secondary battery, for example, a lithium metal secondary battery including a positive electrode having a positive electrode current collector and a positive electrode material mixture layer containing a lithium composite oxide; a negative electrode having a negative electrode current collector and a lithium metal layer; and a separator impregnated with an electrolytic solution is known.

As the electrolytic solution, for example, a nonaqueous electrolytic solution in which an electrolyte salt is dissolved in a nonaqueous solvent is known. Here, the electrolyte salt includes at least one first lithium salt selected from LiPF₆, LiBF₄, LiN(SO₂F)₂, LiN(SO₂CF₃)₂, or LiN(SO₂C₂F₅)₂, and at least one second lithium salt selected from a lithium salt having an oxalic acid skeleton, a lithium salt having a phosphate skeleton, or a lithium salt having a S═O group. The total number of the first lithium salt and the second lithium salt is four or more.

### CITATION LIST

### Patent Document

Patent Document 1: PCT International Publication No. WO 2016/009994

### SUMMARY OF THE INVENTION

However, when charge and discharge are repeated, there is a problem that direct current (DC) resistance of the lithium metal secondary battery becomes high and a capacity retention rate becomes low.

It is an object of the present invention to provide an electrolytic solution capable of reducing DC resistance of a lithium metal secondary battery and increasing a capacity retention rate thereof, even when charge and discharge are repeated.

A first aspect of the present disclosure relates to an electrolytic solution including a lithium salt and an organic solvent, in which the lithium salt has a concentration of 2.0 mol/L or more and 3.0 mol/L or less, the lithium salt includes a first lithium salt and a second lithium salt, the first lithium salt is lithium bis(fluorosulfonyl)imide, and the second lithium salt is one or more selected from the group consisting of lithium hexafluorophosphate, lithium difluoro(oxalato)borate and lithium difluorophosphate.

A second aspect of the present disclosure relates to the electrolytic solution as described in the first aspect, in which the lithium bis(fluorosulfonyl)imide has a concentration of 1.98 mol/L or more and 2.6 mol/L or less.

A third aspect of the present disclosure relates to the electrolytic solution as described in the first or second aspect, in which the lithium hexafluorophosphate has a concentration of 1.0 mol/L or less.

A fourth aspect of the present disclosure relates to the electrolytic solution as described in the first or second aspect, in which the lithium difluoro(oxalato)borate has a concentration of 1.0 mol/L or less.

A fifth aspect of the present disclosure relates to the electrolytic solution as described in the first or second aspect, in which the lithium difluoro(oxalato)borate has a concentration of 0.02 mol/L or more.

A sixth aspect of the present disclosure relates to the electrolytic solution as described in the first or second aspect, in which the lithium hexafluorophosphate has a concentration of 1.0 mol/L or less and the lithium difluorophosphate has a concentration of 0.02 mol/L or more.

A seventh aspect of the present disclosure relates to the electrolytic solution as described in the first or second aspect, in which the lithium difluoro(oxalato)borate has a concentration of 1.0 mol/L or less, and the lithium difluorophosphate has a concentration of 0.02 mol/L or more.

An eighth aspect of the present disclosure relates to the electrolytic solution as described in the first or second aspect, in which the lithium hexafluorophosphate has a concentration of 1.0 mol/L or less, and the lithium difluoro(oxalato)borate has a concentration of 1.0 mol/L or less.

A ninth aspect of the present disclosure relates to the electrolytic solution as described in any one of the first to eighth aspects, in which the organic solvent includes 1,2-dimethoxyethane and a hydrofluoroether.

A tenth aspect of the present disclosure relates to a lithium metal secondary battery having the electrolytic solution as described in any one of the first to ninth aspects.

According to the present invention, it is possible to provide an electrolytic solution capable of reducing the DC resistance of the lithium metal secondary battery and increasing the capacity retention rate thereof, even when charge and discharge are repeated.

### DETAILED DESCRIPTION OF THE INVENTION

Hereinafter, embodiments of the present invention will be described.

### [Electrolytic Solution]

The electrolytic solution of the present embodiment contains a lithium salt and an organic solvent. The lithium salt in the electrolytic solution of the present embodiment has a concentration of 2.0 mol/L or more and 3.0 mol/L or less, and preferably 2.2 mol/L or more and 2.8 mol/L or less. When the concentration of the lithium salt in the electrolytic solution is less than 2.0 mol/L or more than 3.0 mol/L, the DC resistance of the lithium metal secondary battery becomes high and the capacity retention rate thereof becomes low.

The lithium salt includes a first lithium salt and a second lithium salt. Here, the first lithium salt is lithium bis(fluorosulfonyl)imide, and the second lithium salt is one or more selected from the group consisting of lithium hexafluorophosphate, lithium difluoro(oxalato)borate and lithium difluorophosphate.

The lithium bis(fluorosulfonyl)imide in the electrolytic solution of the present embodiment preferably has a concentration of 1.98 mol/L or more and 2.6 mol/L or less, and more preferably 2.0 mol/L or more and 2.4 mol/L or less. When the concentration of the lithium bis(fluorosulfonyl)imide in the electrolytic solution of the present embodiment is 1.98 mol/L or more and 2.6 mol/L or less, the DC resistance of the lithium metal secondary battery can be easily lowered and the capacity retention rate thereof can be easily increased, even when charge and discharge are repeated.

The lithium hexafluorophosphate in the electrolytic solution of the present embodiment preferably has a concentration of 1.0 mol/L or less, and more preferably 0.01 mol/L or more and 0.8 mol/L or less. When the concentration of the lithium hexafluorophosphate in the electrolytic solution of the present embodiment is 1.0 mol/L or less, the DC resistance of the lithium metal secondary battery can be easily lowered and the capacity retention rate thereof can be easily increased even when charge and discharge are repeated.

The lithium difluoro(oxalato)borate in the electrolytic solution of the present embodiment preferably has a concentration of 1.0 mol/L or less, and more preferably 0.01 mol/L or more and 0.8 mol/L or less. When the concentration of the lithium difluoro(oxalato)borate in the electrolytic solution of the present embodiment is 1.0 mol/L or less, the DC resistance of the lithium metal secondary battery can be easily lowered and the capacity retention rate thereof can be easily increased even when charge and discharge are repeated.

The lithium difluorophosphate in the electrolytic solution of the present embodiment preferably has a concentration of 0.02 mol/L or more, and more preferably 0.04 mol/L or more and 0.2 mol/L or less. When the concentration of the lithium difluorophosphate in the electrolytic solution of the present embodiment is 0.02 mol/L or more, the DC resistance of the lithium metal secondary battery can be easily lowered and the capacity retention rate thereof can be easily increased even when charge and discharge are repeated.

The organic solvent is not particularly limited as long as it can dissolve lithium salts, and examples thereof include propylene carbonate, ethylene carbonate, diethyl carbonate, dimethyl carbonate, fluoroethylene carbonate, vinylene carbonate, 1,2-dimethoxyethane, 1,2-diethoxyethane, hydrofluoroether, γ-butyrolactone, tetrahydrofuran, 2-methyltetrahydrofuran, 1,3-dioxolane, 4-methyl-1,3-dioxolane, diethyl ether, sulfolane, methylsulfolane, acetonitrile, propionitrile, anisole, acetic acid esters, butyric acid esters, and propionic acid esters. Two or more types thereof may be used in combination. Among them, a mixed solvent of 1,2-dimethoxyethane and hydrofluoroether is preferable.

The volume ratio of the hydrofluoroether to 1,2-dimethoxyethane in the mixed solvent is preferably 0.02 or more and 0.80 or less, and more preferably 0.05 or more and 0.70 or less. When the volume ratio of the hydrofluoroether to 1,2-dimethoxyethane in the mixed solvent is 0.02 or more, the DC resistance of the lithium metal secondary battery can be easily lowered and the capacity retention rate thereof can be easily increased even when charge and discharge are repeated. On the other hand, when the volume ratio of the hydrofluoroether to 1,2-dimethoxyethane in the mixed solvent is 0.80 or less, lithium bis(fluorosulfonyl)imide is easily dissolved.

Examples of the hydrofluoroether include, but are not limited to, 1,1,2,2-tetrafluoroethyl-2,2,2-trifluoroethyl ether, 1,1,2,2-tetrafluoroethyl-2,2,3,3-tetrafluoropropyl ether, bis(2,2-trifluoroethyl)ether, 1,2-bis(1,1,2,2-tetrafluoroethoxy)ethane, and the like.

### [Lithium Metal Secondary Battery]

In the lithium metal secondary battery of the present embodiment, a separator impregnated with an electrolytic solution is disposed between the positive electrode and the negative electrode. Here, the positive electrode includes a positive electrode current collector and a positive electrode material mixture layer containing a lithium composite oxide. The negative electrode includes a negative electrode current collector and a lithium metal layer.

That is, in the lithium metal secondary battery of the present embodiment, lithium metal is deposited on the negative electrode during charging, and lithium ions are eluted from the negative electrode during discharging. Therefore, the negative electrode of the lithium metal secondary battery of the present embodiment may not have a lithium metal layer in the initial state. In this case, the lithium metal secondary battery is charged before using it, thereby a lithium metal layer is formed on the negative electrode current collector.

The positive electrode current collector is not particularly limited, and examples thereof include aluminum foil.

The positive electrode material mixture layer contains a lithium composite oxide, but may further contain other components.

Examples of the lithium composite oxide include, but are not limited to, LiCoO₂, Li(Ni_{5/10}Co_{2/10}Mn_{3/10})O₂, Li(Ni_{6/10}Co_{2/10}Mn_{2/10})O₂, Li(Ni_{8/10}Co_{1/10}Mn_{1/10})O₂, Li(Ni_{0.8}Co_{0.15}Al_{0.05})O₂, Li(Ni_{1/6}Co_{4/6}Mn_{1/6})O₂, Li(Ni_{1/3}Co_{1/3}Mn_{1/3})O₂, LiCoO₄, LiMn₂O₄, LiNiO₂, LiFePO₄, and the like. Two or more types thereof may be used in combination.

Examples of the other components include a positive electrode active material other than the lithium composite oxide, a conductive additive, a binder, etc.

The negative electrode current collector is not particularly limited, and examples thereof include copper foil.

The material constituting the separator is not particularly limited, and examples thereof include polyolefins such as polyethylene and polypropylene, aramids, polyimides, fluorinated resins, glass fibers, and cellulose fibers.

The lithium metal secondary battery of the present embodiment can be manufactured using well-known methods.

Although the embodiments of the present invention have been described above, the present invention is not limited to the above-described embodiments, and the above-described embodiments may be appropriately modified within the scope of the present invention.

### EXAMPLES

Hereinafter, the Examples of the present invention will be described, but the present invention is not limited to the Examples.

### Example 1

Lithium bis(fluorosulfonyl)imide (LiFSI) and lithium difluorophosphate (LiPO₂F₂) as the lithium salts were dissolved in a mixed solvent of 1,2-dimethoxyethane (DME) and 1,1,2,2-tetrafluoroethyl-2,2,2-trifluoroethyl ether as the hydrofluoroether (HFE) (volume ratio: 0.81:0.19) to obtain an electrolytic solution. At this time, the concentrations of LiFSI and LiPO₂F₂ in the electrolytic solution were set to 2.46 mol/L and 0.04 mol/L, respectively.

### Example 2

An electrolytic solution was obtained in the same manner as in Example 1, except that lithium difluoro(oxalato)borate (LiFOB) was used instead of LiPO₂F₂, and the concentrations of LiFSI and LiFOB in the electrolytic solution were set to 2.35 mol/L and 0.1 mol/L, respectively.

### Example 3

An electrolytic solution was obtained in the same manner as in Example 1 except that lithium hexafluorophosphate (LiPF₆) was used instead of LiPO₂F₂, and the concentrations of LiFSI and LiPF₆ in the electrolytic solution were set to 2.40 mol/L and 0.1 mol/L, respectively.

### Example 4

An electrolytic solution was obtained in the same manner as in Example 1, except that LiPF₆ and LiFOB were used instead of LiPO₂F₂, and the concentrations of LiFSI, LiPF₆ and LiFOB in the electrolytic solution were set to 2.25 mol/L, 0.1 mol/L and 0.1 mol/L, respectively.

### Example 5

An electrolytic solution was obtained in the same manner as in Example 1, except that LiFSI, LiPF₆ and LiPO₂F₂ were used as the lithium salts, and the concentrations of LiFSI, LiPF₆ and LiPO₂F₂ in the electrolytic solution were set to 2.36 mol/L, 0.1 mol/L and 0.04 mol/L, respectively.

### Example 6

An electrolytic solution was obtained in the same manner as in Example 3, except that the concentrations of LiFSI and LiPF₆ in the electrolytic solution were changed to 2.26 mol/L and 0.2 mol/L, respectively.

### Example 7

An electrolytic solution was obtained in the same manner as in Example 3, except that the concentrations of LiFSI, LiPF₆ and LiPO₂F₂ in the electrolytic solution were changed to 2.15 mol/L, 0.2 mol/L and 0.15 mol/L, respectively.

### Example 8

An electrolytic solution was obtained in the same manner as in Example 3 except that LiFOB was used instead of LiPF₆.

### Example 9

An electrolytic solution was obtained in the same manner as in Example 6, except that the concentration of LiPO₂F₂ in the electrolytic solution was changed to 0.08 mol/L.

### Comparative Example 1

An electrolytic solution was obtained in the same manner as in Example 1, except that LiFSI was used as the lithium salt and the concentration of LiFSI in the electrolytic solution was set to 2.50 mol/L.

### Comparative Example 2

An electrolytic solution was obtained in the same manner as in Example 3, except that the concentrations of LiFSI and LiPF₆ in the electrolytic solution were changed to 2.50 mol/L and 1.0 mol/L, respectively.

### [Preparation of Lithium Metal Secondary Battery]

A lithium-nickel-cobalt-manganese composite oxide as the lithium composite oxide, acetylene black as the conductive auxiliary agent, and polyvinylidene fluoride as the binder were mixed to obtain a coating liquid for a positive electrode material mixture layer.

The coating liquid for a positive electrode material mixture layer was applied to an Al foil having an area of 12 cm² and a thickness of 15 μm as a positive electrode current collector and dried to form a positive electrode material mixture layer of 20 mg/cm², followed by rolling to obtain a positive electrode.

As the negative electrode current collector and the separator, a Cu foil having an area of 12 cm² and a thickness of 12 μm and a porous polyolefin film having a thickness of 20 μm, respectively, were used.

The positive electrode (the positive electrode material mixture layer and the positive electrode current collector), the separator, and the negative electrode current collector were laminated in this order, and the separator was impregnated with an electrolytic solution, followed by sealing with a laminate film to obtain a lithium metal secondary battery.

### [Charge-Discharge Test of Lithium Metal Secondary Battery]

The discharge capacity per unit area of lithium metal was defined as 3 mAh/cm², and a charge-discharge test was performed under the following conditions. The lithium metal secondary battery was mounted on a jig, confined at a confining pressure of 0.05 MPa, and then left at a measuring temperature (25° C.) for 1 hour. Next, constant-current charging was carried out at 0.2 C. Here, the conditions for terminating the constant-current charging were that the specified capacity (3 mAh/cm²) was reached, 5 hours have elapsed from the start of the constant-current charging, or that the voltage reached 0.8 V. At this time, lithium metal was deposited on the Cu foil to form a lithium metal layer having a thickness of about 15 μm. Thereafter, the constant-current charging was halted for 5 minutes. Next, constant-current discharging was carried out at 0.2 C. Here, the conditions for terminating the constant-current discharging were that the specified capacity (3 mAh/cm²) was reached, 5 hours have elapsed from the start of the constant-current discharging, or that the voltage reached −0.8 V. Thereafter, the constant-current discharging was halted for 5 minutes. Next, the above-described constant-current discharging and constant-current charging were repeated 50 times.

With respect to the discharge capacity defined per unit area of lithium metal, a current value at which discharging can be completed in one hour was defined as 1 C.

The capacity retention rate was calculated by the following equation:

(capacity at the 50^{th} cycle)/(capacity at the 1^{st} cycle)×100.

Next, the constant-current discharging was carried out at a charging rate of 50%, and after measuring the voltage after 10 seconds, DC resistance (DCR) was calculated by the following equation:

(voltage after 10 seconds)/(current)/(area of current collector).

Table 1 shows the evaluation results of the DCRs and the capacity retention rates of the lithium metal secondary batteries.

TABLE 1

| | | | | | | Charge-discharge | |
|---|---|---|---|---|---|---|---|
| | | | | | | test | |
| | Concentration of lithium salt | | | | | | Capacity |
| | [mol/L] | | | | | DCR | retention |
| | LiFSI | LiPF₆ | LiFOB | LiPO₂F₂ | Total | [Ω/cm²] | rate |
| Example 1 | 2.46 | — | — | 0.04 | 2.50 | 14.6 | 97.8 |
| Example 2 | 2.35 | — | 0.1 | — | 2.45 | 13.9 | 97.2 |
| Example 3 | 2.40 | 0.1 | — | — | 2.50 | 15.0 | 97.0 |
| Example 4 | 2.25 | 0.1 | 0.1 | — | 2.45 | 14.3 | 97.9 |
| Example 5 | 2.36 | 0.1 | — | 0.04 | 2.50 | 14.4 | 98.1 |
| Example 6 | 2.26 | 0.2 | — | 0.04 | 2.50 | 14.2 | 98.3 |
| Example 7 | 2.15 | 0.2 | — | 0.15 | 2.50 | 13.9 | 98.6 |
| Example 8 | 2.36 | — | 0.1 | 0.04 | 2.50 | 13.2 | 98.1 |
| Example 9 | 2.36 | — | 0.1 | 0.08 | 2.54 | 13.0 | 98.5 |
| Comparative | 2.50 | — | — | — | 2.50 | 19.0 | 96.6 |
| Example 1 | | | | | | | |
| Comparative | 2.50 | 1.0 | — | 0.04 | 3.54 | 26.0 | 94.6 |
| Example.2 | | | | | | | |

From Table 1, it is understood that when the electrolytic solutions of Examples 1 to 9 were used, the lithium metal secondary batteries had low DCRs and high capacity retention rates after the charge-discharge tests. On the other hand, since the electrolytic solution of Comparative Example 1 did not contain LiPF₆, LiFOB or LiPO₂F₂, the lithium metal secondary battery had a high DCR and a low capacity retention rate after the charge-discharge test. Further, in the electrolytic solution of Comparative Example 2, since the lithium salt had a total concentration of 3.54 mol/L, the lithium metal secondary battery had a high DCR and a low capacity retention rate after the charge-discharge test.

What is claimed is:

1. An electrolytic solution comprising a lithium salt and an organic solvent,
wherein the lithium salt has a concentration of 2.0 mol/L or more and 3.0 mol/L or less,
the lithium salt comprises a first lithium salt and a second lithium salt,
the first lithium salt is lithium bis(fluorosulfonyl)imide, and
the second lithium salt is one or more selected from the group consisting of lithium hexafluorophosphate, lithium difluoro(oxalato)borate and lithium difluorophosphate.

2. The electrolytic solution according to claim 1, wherein the lithium bis(fluorosulfonyl)imide has a concentration of 1.98 mol/L or more and 2.6 mol/L or less.

3. The electrolytic solution according to claim 1, wherein the lithium hexafluorophosphate has a concentration of 1.0 mol/L or less.

4. The electrolytic solution according to claim 1, wherein the lithium difluoro(oxalato)borate has a concentration of 1.0 mol/L or less.

5. The electrolytic solution according to claim 1, wherein the lithium difluorophosphate has a concentration of 0.02 mol/L or more.

6. The electrolytic solution according to claim 1,
wherein the lithium hexafluorophosphate has a concentration of 1.0 mol/L or less and the lithium difluorophosphate has a concentration of 0.02 mol/L or more.

7. The electrolytic solution according to claim 1,
wherein the lithium difluoro(oxalato)borate has a concentration of 1.0 mol/L or less, and
the lithium difluorophosphate has a concentration of 0.02 mol/L or more.

8. The electrolytic solution according to claim 1,
wherein the lithium hexafluorophosphate has a concentration of 1.0 mol/L or less, and
the lithium difluoro(oxalato)borate has a concentration of 1.0 mol/L or less.

9. The electrolytic solution according to claim 1, wherein the organic solvent includes 1,2-dimethoxyethane and a hydrofluoroether.

10. A lithium metal secondary battery having the electrolytic solution according to claim 1.
